(19) United States
(12) Patent Application Publication
(10) Pub. No.: US 2013/0280100 A1
(43) Pub. Date: Oct. 24, 2013

(54) ELECTRONICALLY COMMUTATED PUMP MOTOR CIRCUIT

(71) Applicant: SNTECH, INC., Phoenix, AZ (US)

(72) Inventors: Jared Zumstein, Fort Wayne, IN (US); Luis Morales, Fort Wayne, IN (US); Stephen Zavodny, Fort Wayne, IN (US)

(73) Assignee: SNTech, Inc., Phoenix, AZ (US)

(21) Appl. No.: 13/866,679

(22) Filed: Apr. 19, 2013

Related U.S. Application Data
(60) Provisional application No. 61/637,149, filed on Apr. 23, 2012.

(51) Int. Cl. H02P 6/08; H02P 6/00

(52) U.S. Cl. CPC H02P 6/08; H02P 6/001
USPC 417/44.1; 318/400.3; 318/400.22

(57) ABSTRACT

An electronically commutated pump motor circuit comprises an input configured, to receive at least a first range of voltages, and a power conditioning circuit. The power conditioning circuit includes an active power factor correction circuit, coupled to the input. The power conditioning circuit is configured to receive the first range of voltages and automatically output to an electronically commutated motor (optionally a pump motor) a substantially constant DC voltage for input voltages within the first range of input voltages, boosted with respect to a voltage received at the input, to thereby maintain a substantially constant motor shaft speed for any voltage within the first range of voltages.

### CROSS-REFERENCE TO RELATED APPLICATIONS

This application claims the benefit under 35 U.S.C. §119 of U.S. Provisional Application No. 61/637,149, filed Apr. 23, 2012, the content of which is incorporated herein by reference in its entirety.

### BACKGROUND OF THE INVENTION

1. Field of the Invention

The invention generally relates to a motor controller used in powering a device, such as a pump drive system or an air moving system, and an electronically commutated motor, such as a pump motor.

2. Description of the Related Art

The residential pool has been a large part of many warm-weather backyard living spaces for many years, though ever-increasing energy rates have driven many homeowners to rethink whether the costs of having a pool in their backyard outweigh the benefits. The industry standard conventional motor for many years has been a single speed, single phase induction motor either in the form a split phase (SP), capacitor start/induction run (CSIR), capacitor start/capacitor run (CSCR), or permanent split capacitor (PSC). In more recent years, states such as California and Florida have begun to mandate the use of more energy efficient pumping solutions to reduce overall grid demand, through the use of two speed induction motors or variable speed motors, typically employing a brushless DC motor with a tuned AC/DC inverter drive.

The commercially available variable speed pool pumps have often been offered only in 208-230V form, which may be acceptable to certain homeowners with pools constructed in the early 1990's through today, as many more modern houses tend to have 208-230V available. However, those with smaller volume, older pools often-times operate at 115V and often do not have 208-230V service, and so such pool owners have had to find alternate solutions to enjoy the energy saving benefits of variable speed pumps. These solutions have included purchasing a step-up transformer or installing an 115V two speed induction motor.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example embodiment includes an electronically commutated pump motor circuit comprising an input configured to receive at least a first range of voltages, and a power conditioning circuit. The electronically commutated pump motor circuit is electrically and operatively coupled to an electronically commutated motor. The power conditioning circuit includes an active power factor correction circuit, coupled to the input. The power conditioning circuit is configured to receive the first range of voltages and automatically output to the electronically commutated motor a substantially constant DC voltage for input voltages within the first range of input voltages, boosted with respect to a voltage received at the input, to thereby maintain a substantially constant motor shaft speed for any voltage within the first range of voltages. The electronically commutated motor may be an aquatic pump motor.

An example embodiment includes an electronically commutated pump motor circuit, comprising: an input configured to receive at least a first range of voltages, the first range of voltages including at least 115 VAC; a transformer-less power conditioning circuit, including at least an active power factor correction circuit, coupled to the input, the power conditioning circuit configured to: receive the first range of voltages, automatically output to an electronically commutated pump motor a substantially constant DC voltage for input voltages within the first range of input voltages, boosted with respect to a voltage received at the input, to thereby maintain a substantially constant motor pump motor shaft speed for any voltage within the first range of voltages.

An example embodiment includes an electronically commutated motor system, comprising: a power conditioning circuit, including at least an active power factor correction circuit providing a near unity power factor, coupled to an input, the power conditioning circuit configured to receive a first range of voltages via the input; an electronically commutated motor, having a motor shaft, coupled to the power conditioning circuit, wherein the power conditioning circuit is configured to: output a substantially constant DC voltage for input voltages within the first range of input voltages, boosted with respect to a voltage received at the input, to thereby maintain a substantially constant motor shaft speed for any voltage within the first range of voltages.

An example embodiment includes a method of controlling an electronically commutated motor, comprising: receiving, at a power conditioning circuit coupled to an input, AC voltages in a first voltage range, providing, via an active power factor correction circuit, a near unity power factor, outputting, by the power conditioning circuit, a substantially constant DC voltage for input voltages within the first range of input voltages, boosted with respect to a voltage received at the input, causing, by the power conditioning circuit, an electronically commutated motor coupled to the power conditioning circuit to maintain a substantially constant motor shaft speed for any voltage within the first range of voltages.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example motor controller circuit.

### DETAILED DESCRIPTION OF CERTAIN EMBODIMENTS

Certain embodiments described herein address some or all of the foregoing problems with conventional pump motors. Certain embodiments provide a solution by enabling an 115VAC voltage input to be accepted (e.g., directly, without a step up transformer) by an electronically communicated motor (e.g., a variable speed induction motor for use in an aquatic pump to pump water), without requiring an 115V two speed induction motor.

An example embodiment includes an electronically communicated motor and drive configured to accept the 115VAC input directly via the use of a power conditioning front end. In an example embodiment, the front end includes an active power factor correction circuit (APFC). By way of example and not limitation, the APFC may comprise a circuit controller, a tuned inductor, diode, and transistor network with a defined switching frequency. An example APFC circuit is described in greater detail elsewhere herein. By providing the APFC circuit on the input side of the motor drive, near unity power factor (with current and voltage substantially in phase) may optionally be achieved, thus maximizing or enhancing the output power/torque available from a conventional residential 115V outlet.

Certain embodiments additionally provide “universal” input functionality (e.g., configured to receive multiple standard voltage levels or a range of input levels) via the APFC circuit, enabling the acceptable input voltage range to vary between 85V and 264VAC (although certain embodiments may be configured to accept other voltages and voltage ranges), and the frequency to vary between 50 and 60 Hz (although certain embodiments may be configured to accept other frequency ranges), without materially changing the shaft rotational speed and thus without materially altering the flow and pressure generated by the aquatic pump. The motor speed may be manually set by a user via one or more inputs. For example, user accessible buttons/sensors may be provided (e.g., on a top or side panel or otherwise) via which the user may select a motor speed. By way of illustration, the system may be configured to configure a motor speed associated with a particular user control or control setting. Thus, for example, one or more controls may be provided that enable the user to select one of multiple speeds, wherein the user may have preconfigured the speed associated with respective controls.

A function of the APFC circuit is to boost the input AC voltage to a substantially constant DC bus voltage (e.g., about 400VDC or other desired voltage), without a step-up transformer, given the proper calibration of the circuit controller parameters. Therefore, this enables the motor to accept a wide range of voltage/frequency across the “universal” input and provides the desired output within the design envelope of the motor. Thus, certain embodiments of the motor system described herein include an auto regulating or limiting input.

Conversely, the degree of independence of the speed relative to the input voltage is quite different in a standard induction motor of aforementioned variety, where a variance in the input voltage will drive a resultant change in the shaft speed and thus pump performance.

Certain embodiments of the motor design described herein provide for switchless and/or jumper-less dual voltage (115/208-230V) operation or operation over a range of voltages, in contrast to conventional designs of electronically communicated motors and induction motors, which require a contact/switch or variation in a jumper connection within the drive circuit to allow for a change in input voltage acceptance. This, again, is facilitated by the active power factor correction/power conditioning drive input, which provides the ability to operate with a wide range of input voltages and which provides power regulation.

In summary, certain embodiments of a residential aquatic pump motor design include some or all of the following features:

1. 115VAC input to an electronically communicated motor

2. “Universal” input—85-264VAC, 50/60 Hz via an active power factor correction power conditioning circuit to maximize output power

3. Speed independent of input voltage and frequency within the defined universal voltage and frequency input range

4. Auto-regulated input (ARI) allowing for jumper-less/switchless dual (or more than dual) voltage functionality

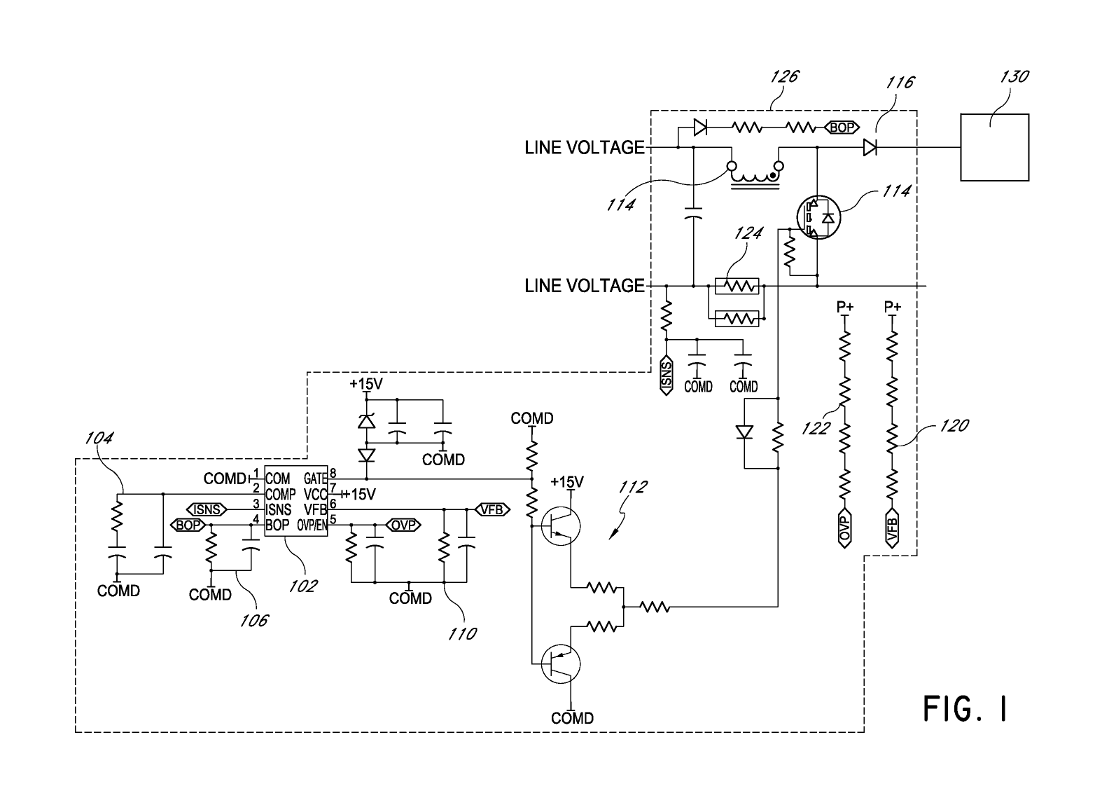

In addition, certain embodiments may detect and safely handle brown-out, over-voltage and over-current faults. For example, embodiments of the example APFC circuit and the motor drive provide some or all of the following functions:
Brown-out protection (under-voltage condition, where the input voltage falls below a threshold minimum desired voltage). This feature is used to sense the input voltage and enter a fault handling process if the input voltage falls below the designed specification. In the example embodiment illustrated in FIG. 1, this is accomplished through a high impedance feedback resistor network placed on the rectified AC input line, although other techniques may be used. The brown-out fault causes the APFC controller (e.g., PFC circuit 102) to enter standby mode, consequently a motor drive microcontroller will detect an under-voltage condition (e.g., via a step down resistor network coupled to the DC bus voltage (e.g., the 40 V bus voltage) and the motor PWM (pulse width modulator) will be turned off, thereby causing the motor to cease operating. Once the APFC controller detects that the brown-out voltage condition has terminated and the input voltage is at or above a desired threshold, the APFC controller will return to normal operation, the motor PWM will be turned back on, and the motor may operate normally. The brown-out protection function may be set to trigger at a lower voltage threshold than the under-voltage threshold of the motor drive to ensure that the APFC does not turn off while the motor is still running. Otherwise, currents would jump, because, in this example, the DC bus would not be at the boosted 400VDC level but rather 320VDC.
Over-voltage protection (where the input voltage exceeds a desired threshold). In the example APFC embodiment illustrated in FIG. 1, a sensor is used to sense the boosted voltage (DC main) and the illustrated circuit is configured to enter a fault condition if the voltage range exceeds the designed specification. If an over-voltage condition occurs, the APFC circuit will latch off until the input voltage falls below the over-voltage threshold. Optionally, the over-voltage condition causes the APFC controller to enter standby mode, consequently the motor drive microcontroller will detect an over-voltage condition and the motor PWM will be turned off, thereby causing the motor to cease operating. Once the APFC controller detects that the over-voltage condition has terminated and the input voltage is at or below a desired threshold, the APFC controller will return to normal operation, the motor PWM will be turned back on, and the motor may operate normally. Optionally, the motor drive may include a manual reset control which a user would need a activate and/or and the user would need to recycle power to the motor drive electronics (e.g., by manually turning power on and off) in order to reset the motor drive if the motor drive has latched off as a result of an over-voltage condition.
Over-current protection (where the system current exceeds a desired threshold). This feature is used to sense the system current and provide feedback, optionally on a cycle-by-cycle basis. In an example APFC configuration, current sense resistors are placed below the system ground on the return path to a bridge rectifier. If the peak current exceeds a maximum design threshold, an overcurrent fault will be generated. If an over-current condition is detected by the APFC circuit, the APFC will latch off until reset. Similarly, if an over-current condition is detected by the motor drive, the motor drive will latch off until reset. Optionally, the over-current condition causes the APFC controller to enter standby mode, consequently the motor drive microcontroller will detect an over-current condition and the motor PWM will be turned off, thereby causing the motor to cease operating. Once the APFC controller detects that the over-current condition has terminated and the input current is at or below a desired threshold, the APFC controller will return to normal operation, the motor PWM will be turned back on, and the motor may operate normally. Optionally, the reset may involve a user activating a manual reset control and/or the user recycling power to the motor drive electronics (e.g., by manually turning power on and off). Optionally, the APFC circuit and/or the motor drive will reset once the over-current condition is detected to have terminated.

An example operation of the APFC circuit will now be described.

The example APFC (Active Power Factor Correction) design utilizes a multi-loop approach (in the example described herein, two loops are provided, an inner loop and an outer loop). The relatively slower outer loop monitors the voltage feedback signals in order to provide brown-out and overvoltage protection, and to maintain output voltage regulation. For example, the outer loop may be used to control the input current magnitude to thereby maintain DC bus voltage regulation. The relatively faster inner loop is a current monitoring loop and is utilized to monitor the boost inductor current information in order to generate a PWM (pulse width modulated) signal that corresponds to (e.g., is proportional to) the detected sinusoidal variation. The inner current loop may be used to determine the substantially instantaneous duty cycle for a given switching cycle. The over-current protection is monitored through the faster inner loop. The inner current loop may be used to provide power factor correction.

Using the CCM (Continuous Conduction Mode) Boost Topology, the DC positive rail is substantially maintained at a design fixed voltage, thus allowing for a “universal” voltage input range capable of receiving many common input voltages. This, however, may be accomplished utilizing other APFC topologies and the present invention is not limited to utilizing the specific APFC topologies disclosed herein. For example, one or more of the following topologies may be used: CCM (Critical Conduction Mode), Bridgeless, Continuous Off Time, or Interleaved. Further, while the foregoing description contemplates that certain embodiments may be used in the context of a pool pump for illustrative purposes, they may be used in other applications as well, such as in air movement applications (e.g. HVAC and refrigeration applications).

FIG. 1 illustrates an example circuit diagram of an APFC device. Other embodiments may utilize different topologies, components, and/or component values. The APFC device may be coupled to a powered device 130, such as a pool pump motor. The example APFC device is configured to accept a range of input voltages (e.g., about 90 to 230 VAC) while providing a substantially constant output voltage (e.g., about 400 V to the pool pump motor). The example device includes a power factor correction (PFC) circuit 102. For example, the PFC circuit 102 may be an IR 1153 integrated circuit from International Rectifier, although other devices may be used. The PFC circuit 102 may be utilized to provide programmable soft start, input-line sensed brown-out protection (BOP), overvoltage protection, cycle-by-cycle peak current limit, open loop protection (OLP), and/or under voltage lock-out (UVLO). Optionally, rather than using an analog PFC circuit, a DSP (digital signal processor) device may be used to perform both the APFC and motor drive functions (e.g., using the same chip). In certain embodiments, this obviates the need to have more than one controller to perform such functions.

The PFC circuit 102 may be referenced to a potential, such as ground, via the common (COM) input. Diagnostic signals are received via an output voltage feedback sense input (VFB), a voltage loop compensation input (COMP), and a current sense input (ISNS). The diagnostic signals are used to achieve power factor correction and to regulate the output voltage.

The VFB input may be used to sense the DC bus voltage, as stepped down by the step down resistor network 120. The COMP input may be used to compensate the voltage feedback loop to set the desired transient response characteristics and to set a soft start time. The COMP input may be AC coupled to common or ground (COMD) via capacitor-resistor circuit 104. The slow start time may be controlled via the selection of the capacitor and resistor values, which in turn affect the capacitor charge time. The ISNS input may be used to sense the inductor current of the boost inductor 114. For example, the ISNS input may be connected to the negative rail of the shunt 124, which follows the current through the inductor 114. The inductor current may be used by the PFC circuit 102 to determine, at least in part, the PFC switch duty cycle.

The brown-out protection (BOP) input may be used to sense the rectified AC input line voltage via a rectifying circuit and a step down resistor network 126. The stepped down, rectified AC input may be filtered via a capacitor-resistor circuit 106 on the BOP input. During start-up, the PFC circuit 102 is held in stand-by mode when the BOP input voltage is less than a first set threshold. When the BOP input voltage exceeds this threshold (which prior to the step down, may be about 90-95 VAC or other desired threshold), the PFC circuit 102 enters normal operation. If the BOP input voltage later falls below a second threshold (indicating a brown-out fault condition), then the brown-out condition is detected, the COMP input is actively discharged, and the PFC circuit 102 enters a standby mode. In standby mode the gate drive output (GATE) may be disabled and current consumption may optionally be greatly reduced (e.g., to a few milliamps or less). The second threshold may be set to be less than the first threshold (e.g., half or less of the first threshold). If the BOP voltage then exceeds the first threshold (or other specified operating threshold), the PFC circuit 102 transitions from standby mode to normal operating mode.

The OVP input of the PFC circuit 102 is used to sense an over-voltage condition and provide overvoltage protection (e.g., when the DC bus voltage exceeds about 425-430 V in an example embodiment). The DC bus voltage is connected to the OVP input via step down resistor network 122. An overvoltage fault may be detected when the stepped down voltage at the OVP input exceeds a first overvoltage circuit threshold (e.g., 106% of a reference voltage or other specified percentage). When an overvoltage fault is detected by the PFC circuit 102 it may disable the gate drive output (GATE) until the overvoltage fault condition ceases (e.g., when the OVP input fall below a second threshold, such as 103% of the reference voltage or other specified percentage—preferably different than the first overvoltage circuit threshold to avoid voltage loop instability). Optionally, the voltage level at which overvoltage protection is triggered may be set using the resistor network 110 (e.g., by a user selecting appropriate values for the network 110).

A push pull drive circuit 112 is connected to and driven by the PFC circuit 102 GATE drive output via biasing circuit 108. The push pull drive circuit 112 is connected to a switch 114 (e.g., an IGBT transistor switch). The GATE output provides a pulse width modulated control signal that determines the on/off duty cycle of the switch 114. When the switch 114 is switched on by the PFC 102, the switch 114 conducts current from the inductor 114, and the inductor 114 stores magnetic field energy. When the switch 114 is switched off by the PFC 102, current flows to the powered device 130 (e.g., the pool pump motor) via the boost diode 116, which provides a rectified, substantially constant output voltage.

When the input voltage is about 115 VAC, certain embodiments of the APFC device may optionally provide about 13-14 amps of current to a powered device (e.g., a pool pump motor) at a boost voltage of about 400 V. When the input voltage is about 230 VAC, certain embodiments of the APFC device may optionally provide about 8-11 amps of current to a powered device (e.g., a pool pump motor) at a boost voltage of about 400 V.

Though example embodiments of a pump motor and circuitry have been described in detail above, it should be understood that the invention is not limited to such examples. Generally, where integrated circuit chips have been employed, discrete components could be used, and where discrete components have been used integrated circuit chips may be employed. Having illustrated and described the principles of the invention in example embodiments, it should be apparent to those skilled in the art that such embodiments can be modified in arrangement and detail.

What is claimed is:

1. An electronically commutated pump motor circuit, comprising:
an input configured to receive at least a first range of voltages, the first range of voltages including at least 115 VAC;
a transformer-less power conditioning circuit, including at least an active power factor correction circuit, coupled to the input, the power conditioning circuit configured to:
receive the first range of voltages,
automatically output to an electronically commutated pump motor a substantially constant DC voltage for input voltages within the first range of input voltages, boosted with respect to a voltage received at the input, to thereby maintain a substantially constant motor pump motor shaft speed for any voltage within the first range of voltages.

2. The electronically commutated pump motor circuit as defined in claim 1, wherein the electronically commutated pump motor circuit is further configured to operate the pump motor over the first range of voltages without manipulation of a jumper or switch by a user to enable operation at different voltages within the first range of voltages.

3. The electronically commutated pump motor circuit as defined in claim 1, wherein the first range includes 115VAC and 230VAC.

4. The electronically commutated pump motor circuit as defined in claim 1, wherein the power conditioning circuit is further configured to operator at an input frequency ranging from 50 Hz to 60 Hz.

5. The electronically commutated pump motor circuit as defined in claim 1, wherein the power conditioning circuit is further configured to provide brown-out protection.

6. The electronically commutated pump motor circuit as defined in claim 1, wherein in response to detecting a brown-out condition, the power conditioning circuit is further configured to enter a standby mode, causing a pump motor pulse width modulator to turn off.

7. The electronically commutated pump motor circuit as defined in claim 1, wherein the power conditioning circuit is further configured to provide overvoltage protection.

8. The electronically commutated pump motor circuit as defined in claim 1, wherein in response to detecting an over-voltage condition, the power conditioning circuit is further configured to enter a standby mode, causing a pump motor pulse width modulator to turn off.

9. The electronically commutated pump motor circuit as defined in claim 1, wherein the power conditioning circuit is further configured to provide over-current protection.

10. The electronically commutated pump motor circuit as defined in claim 1, wherein in response to detecting an over-current condition, the power conditioning circuit is further configured to enter a standby mode, causing a pump motor pulse width modulator to turn off.

11. The electronically commutated pump motor circuit as defined in claim 1, wherein the power conditioning circuit is further configured to provide a near unity power factor.

12. The electronically commutated pump motor circuit as defined in claim 1, wherein the pump comprises an aquatic pump.

13. The electronically commutated pump motor circuit as defined in claim 1, wherein the first voltage comprises 85VAC and 264VAC.

14. The electronically commutated pump motor circuit as defined in claim 1, wherein the pump is an aquatic pump, and the power conditioning circuit is configured to operate at any voltage within the first range of voltages without materially altering flow and pressure generated by the aquatic pump.

15. An electronically commutated motor system, comprising:
a power conditioning circuit, including at least an active power factor correction circuit providing a near unity power factor, coupled to an input, the power conditioning circuit configured to receive a first range of voltages via the input;
an electronically commutated motor, having a motor shaft, coupled to the power conditioning circuit, wherein the power conditioning circuit is configured to:
output a substantially constant DC voltage for input voltages within the first range of input voltages, boosted with respect to a voltage received at the input, to thereby maintain a substantially constant motor shaft speed for any voltage within the first range of voltages.

16. The electronically commutated motor system as defined in claim 15, wherein the power conditioning circuit is further configured to operate the electronically commutated motor over the first range of voltages without manipulation of a jumper or switch by a user to enable operation at different voltages within the first range of voltages.

17. The electronically commutated motor system as defined in claim 15, wherein the power conditioning circuit is transformer-less.

18. The electronically commutated motor system as defined in claim 15, wherein the first range includes 115VAC and 230VAC.

19. The electronically commutated motor system as defined in claim 15, wherein the power conditioning circuit is further configured to operator at an input frequency ranging from 50 Hz to 60 Hz.

20. The electronically commutated motor system as defined in claim 15, wherein in response to detecting a brown-out condition, the power conditioning circuit is further configured to enter a standby mode, causing a pulse width modulator to turn off.

21. The electronically commutated motor system as defined in claim 15, wherein in response to detecting an over-voltage condition, the power conditioning circuit is further configured to enter a standby mode, causing a pulse width modulator to turn off.

22. The electronically commutated motor system as defined in claim 15, wherein in response to detecting an over-current condition, the power conditioning circuit is further configured to enter a standby mode, causing a motor pulse width modulator to turn off.

23. The electronically commutated motor system as defined in claim 15, wherein the electronically commutated motor comprises an aquatic pump motor, and the power conditioning circuit is configured to operate at any voltage within the first range of voltages without materially altering flow and pressure generated by the aquatic pump motor.

24. A method of controlling an electronically commutated motor, comprising:
receiving, at a power conditioning circuit coupled to an input, AC voltages in a first voltage range,
providing, via an active power factor correction circuit, a near unity power factor,
outputting, by the power conditioning circuit, a substantially constant DC voltage for input voltages within the first voltage range, boosted with respect to a voltage received at the input,
causing, by the power conditioning circuit, an electronically commutated motor coupled to the power conditioning circuit to maintain a substantially constant motor shaft speed for any voltage within the first voltage range.

25. The method as defined in claim 24, wherein the power conditioning circuit is further configured to operate the electronically commutated motor over the first voltage range without manipulation of a jumper or switch by a user to enable operation at different voltages within the first voltage range.

26. The method as defined in claim 24, wherein the power conditioning circuit is transformer-less.

27. The method as defined in claim 24, the method further comprising:
detecting a brown-out condition; and
at least partly in response to detecting the brown-out condition, causing the power conditioning circuit to enter a standby mode and a pulse width modulator to turn off.

28. The method as defined in claim 24, the method further comprising:
detecting an over-voltage condition; and
at least partly in response to detecting the over-voltage condition, causing the power conditioning circuit to enter a standby mode and a pulse width modulator to turn off.

29. The method as defined in claim 24, the method further comprising:
detecting an over-current condition; and
at least partly in response to detecting the over-current condition, causing the power conditioning circuit to enter a standby mode and a pulse width modulator to turn off.
